(19) United States
(12) Patent Application Publication
(10) Pub. No.: US 2004/0012798 A1
(43) Pub. Date: Jan. 22, 2004

(54) Media handling device having media optimization

(76) Inventor: Paul L. Jeran, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/198,977

(22) Filed: Jul. 19, 2002

(51) Int. Cl. H04N 1/00; G06F 11/30

(52) U.S. Cl. 358/1.9; 358/504; 358/406

(57) ABSTRACT

This invention relates to a system that allows users or after-market suppliers to optimize media-handling device process parameters so that a broader range of media can be used on the device. Such structures of this type, generally, employ a system that is internal to the media-handling device that would print a series of patches or other similar visual measurement targets that would allow visual measurement by the user of various image quality attributes produced by the media-handling device in order to manually calibrate the media-handling device to the desired media. By optimizing the quality of several measurement targets, an optimal set of printing parameters could be determined. These parameters would then be saved within the device for future use. Some examples of the targets that could placed on the media could be, but are not limited to, patches, scatter targets, gray and color step wedges, resolution targets, fixing targets or the like.

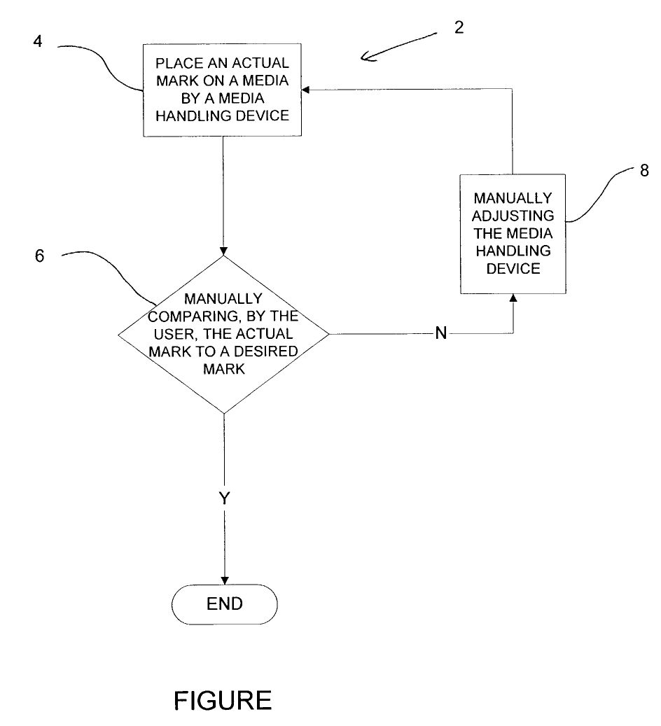

### FIELD OF THE INVENTION

This invention relates to a system that allows users or after-market suppliers to optimize media-handling device process parameters so that a broader range of media can be used on the device. Such structures of this type, generally, employ a system that is internal to the media handling device. The invention discloses a system that would print a series of patches or other similar visual measurement targets that would allow visual measurement by the user of various image quality attributes produced by the media-handling device in order to manually calibrate the media-handling device to the desired media. By optimizing the quality of several measurement targets, an optimal set of printing parameters could be determined. These parameters would then be saved within the device for future use. Some examples of the targets that could placed on the media could be, but are not limited to, patches, scatter targets, gray and color step wedges, resolution targets, fixing targets or the like. Some examples of media-handling device operating characteristics that could be used for calibration could be, but are not limited to, developer, charge and transfer biases; fuser temperature; drop drive voltage; laser power and ink dry time.

### DESCRIPTION OF THE RELATED ART

Prior to the present invention, as set forth in general terms above and more specifically below, it is known, in the media identification art, to employ a variety of methods to identify the media. Exemplary of such prior art are commonly assigned U.S. Pat. No. 6,047,110 ('110) to J. C. Smith, entitled “Method and Apparatus for Identifying a Print Media Type” and commonly assigned U.S. Pat. No. 6,291,829 ('829) to R. R. Allen et al., entitled “Identification of Recording Medium in a Printer.” The '110 and '829 references describe systems where combinations of LEDs and photodetectors are placed on one side or both sides of the media and various combinations of reflected and transmitted light are measured. Different media types will have distinctive “signatures” or combinations of light levels. By comparing the “signature” of the media in question with a set of known media, the media in the media-handling device can be identified. While these systems have met with a modicum of success, these systems utilize media sensors that can add to the cost of a media-handling device, particularly a low end (low cost) media-handling device. Also, these systems require prior characterization of possibly a large number of media. Finally, these systems may have difficulty in recognizing environmental effects on media properties, such as the moisture sensitivity of the media. Therefore, a more advantageous system would be one that was able to avoid the use of expensive sensors, but was able to calibrate the media-handling device to the actual characteristics of the media while recognizing any environmental effects on the media.

It is further known, in the media sensing art, to employ a variety of methods to determine the media quantity and media type. Exemplary of such prior art is commonly assigned U.S. Pat. No. 6,157,791 ('791) to R. E. Haines et al., entitled “Sensing Media Parameters.” The '791 reference describes a system where electrodes are placed on either side of the media and the AC impedance of the resulting capacitor is measured at a number of different frequencies. Different media types will have a distinctive “signature” or combinations of capacitance and loss (dissipation factor) at these frequencies. By comparing the “signature” of the media in question with a set of known media, the media in the media-handling device can be identified. While this system has also met with a modicum of success, this system requires that the media be fed through a small nap that adds mechanical complexity and cost, as well as making the media-handling device more subject to jamming. Also, the system requires prior characterization of possibly a large number of media and does not address the problem of how new media types can be accommodated. Finally, the system may have difficulty in recognizing environmental effects on media properties. Therefore, a further advantageous system would be one that would economically, accurately, and efficiently calibrate the media-handling device to the characteristics of the actual media while recognizing any environmental effects on the media.

It is apparent from the above that there exists a need in the art for a media-handling device calibration system which is capable of calibrating the media-handling device to the characteristics of the actual media while recognizing any environmental effects on the media, but which at the same time avoids the use of expensive media characteristic sensors. It is a purpose of this invention to fulfill this and other needs in the art in a manner more apparent to the skilled artisan once given the following disclosure.

### SUMMARY OF THE INVENTION

Generally speaking, this invention fulfills these needs by providing a method for manually calibrating a media-handling device, wherein the method is comprised of the steps of: placing an actual mark upon a media by a media-handling device; manually comparing, by a user, the actual mark with a desired mark; and manually calibrating, if necessary, the media-handling device.

In certain preferred embodiments, the actual mark can be, but is not limited to, patches, scatter targets, gray and color step wedges, resolution targets, fixing targets or the like. Also, the media-handling device, preferably, is a printer. Finally, the media-handling device is calibrated by manipulating the operating characteristics of the media-handling device.

In another further preferred embodiment, the manual calibrating system of the present invention would allow users or after-market suppliers to optimize media handling device process parameters so that a broader range of media can be used on the media-handling device. This can be done without any additional burden being placed upon the original equipment manufacturer (OEM).

The preferred calibrating system, according to this invention, offers the following advantages: ease-of-use; excellent media-handling device calibration characteristics; ability to adjust to a variety of media types; ability to adjust to a variety of media conditions; reduced media-handling device cost; and good durability. In fact, in many of the preferred embodiments, these factors of ease-of-use, excellent media-handling device characteristics, ability to adjust to a variety of media types, ability to adjust to variety of media conditions, and reduced media-handling device cost are optimized to an extent that is considerably higher than heretofore achieved in prior, known calibration systems.

The above and other features of the present invention, which will become more apparent as the description proceeds, are best understood by considering the following detailed description in conjunction with the accompanying drawing FIGURE and in which:

### BRIEF DESCRIPTION OF THE DRAWING

The FIGURE is a flowchart that illustrates a method for manually calibrating a media-handling device, according to one embodiment of the present invention.

### DETAILED DESCRIPTION OF THE INVENTION

With reference to the FIGURE, there is illustrated one preferred embodiment for use of the concepts of this invention. In the FIGURE, method 2 for manually calibrating a media-handling device is illustrated. Method 2, preferably, includes, in part, the steps of: placing an actual mark on a media by a media-handling device (step 4); manually comparing, by the user, the actual mark placed on the media by the media-handling device to a desired mark (step 6); and manually adjusting, if necessary, the media-handling device by the user (step 8).

With respect to step 4, the actual mark can be, but is not limited to, patches, scatter targets, gray and color step wedges, resolution targets, fixing targets or the like. It is the understood that the media-handling device can be any suitable device, such as a printer, which is capable of placing a mark upon the media. It is to be further understood that the term “media” refers to any suitable tangible medium, such as paper, that is capable of having markings/writing placed upon it.

With respect to step 6, the user compares the actual mark with a desired mark in order to determine if the media-handling device is properly calibrated to that particular media. In this manner, the user, for example, can print a series of “patches” or marks that would allow visual measurement of various image quality attributes. It is to be understood that when the media-handling device is to be calibrated to a new media, these “patches” or marks are printed using a base line set of default process parameters.

With respect to step 8, after visually evaluating the sample, the user could then, if necessary, conventionally adjust various process parameters of the media-handling device that correspond to improving one of the attributes on the page. Some examples of media-handling device operating characteristics that could be used for calibration could be, but are not limited to, developer, charge and transfer biases; fuser temperature; drop drive voltage; laser power and ink dry time. It is to be understood that multiple operating parameters of the media-handling device could be adjusted sequentially or partially by the user and/or a conventional computing device, such as through the use of software located on a PC. This would allow for a better optimization to take place because the effects of changing one parameter would be taken into account in the next test page. This allows the user to calibrate the media-handling device to the particular media. For example, this allows the user to calibrate a printer possibly beyond its normal operating parameters, such as in a high-humidity and high-heat environment. It is to the understood that if the media-handling device has to be calibrated to the particular media, the user could then go back to step 4, as discussed above, and place another mark or set of marks on a different region of the same piece of media or on a different piece of the same type of media and evaluate the results. In this manner, additional calibrations to the media-handling device can be made until the print quality of the various “patches” or marks is optimized.

Finally, this set of optimal calibration values for the media-handling device can be conventionally saved and related to that certain type of media for use in the later jobs. For example, the optimized operating parameters for a particular media, when used in a particular media-handling device, can be conventionally stored on a database and conventionally retrieved by the user when the user desires to use that particular media in that particular media-handling device. It is also to be understood that once the optimal media-handling device operating parameters for a particular media have been determined, this information could be conventionally relayed to other similar media handling devices. In this manner, if the particular media is encountered by other similar media-handling devices, the user or other users should not have to calibrate those other similar media-handling devices.

Once given the above disclosure, many other features, modifications or improvements will become apparent to the skilled artisan. Such features, modifications or improvements are, therefore, considered to be a part of this invention, the scope of which is to be determined by the following claim.

What is claimed is:

1. A method for manually calibrating a media-handling device, comprising the steps of:
placing an actual mark upon a media by a media-handling device;
manually comparing, by a user, said actual mark with a desired mark; and
manually calibrating, if necessary, said media-handling device.

2. The method, as in claim 1, wherein said actual mark is further comprised of:
patches.

3. The method, as in claim 1, wherein said actual mark is further comprised of:
scatter targets.

4. The method, as in claim 1, wherein said actual mark is further comprised of:
gray and color step wedges.

5. The method, as in claim 1, wherein said actual mark is further comprised of:
resolution targets.

6. The method, as in claim 1, wherein said actual mark is further comprised of:
fixing targets.

7. The method, as in claim 1, wherein said media is further comprised of:
paper.

8. The method, as in claim 1, wherein said media-handling device is further comprised of:
a printer.

9. The method, as in claim 1, wherein said placing step is further comprised of the step of:
printing said mark on said media.

10. The method, as in claim 8, wherein said placing step is further comprised of the step of:
printing said mark on said media with said printer.

11. The method, as in claim 1, wherein said calibrating step is further comprised of the step of:
adjusting various process parameters of said media-handling device.

12. The method, as in claim 1, wherein said method is further comprised of the steps of:
placing a second actual mark upon said media by said media-handling device;
manually comparing, by said user, said second actual mark with said desired mark; and
manually calibrating, if necessary, said media-handling device.

13. A method for manually calibrating a printing device, comprising the steps of:
placing an actual mark upon a media by a printing device;
manually comparing, by a user, the actual mark with a desired mark; and
manually calibrating, if necessary, said printing device.

14. The method, as in claim 13, wherein said actual mark is further comprised of:
patches.

15. The method, as in claim 13, wherein said actual mark is further comprised of:
scatter targets.

16. The method, as in claim 13, wherein said actual mark is further comprised of:
gray and color step wedges.

17. The method, as in claim 13, wherein said actual mark is further comprised of:
resolution targets.

18. The method, as in claim 13, wherein said actual mark is further comprised of:
fixing targets.

19. The method, as in claim 13, wherein said media is further comprised of:
paper.

20. The method, as in claim 13, wherein said placing step is further comprised of the step of:
printing said mark on said media.

21. The method, as in claim 20, wherein said placing step is further comprised of the step of:
printing said mark on said media with said printer.

22. The method, as in claim 13, wherein said calibrating step is further comprised of the step of:
adjusting various process parameters of said printing device.

23. The method, as in claim 13, wherein said method is further comprised of the steps of:
placing a second actual mark upon said media by said printing device;
manually comparing, by said user, said second actual mark with said desired mark; and
manually calibrating, if necessary, said printing device.

24. A means for manually calibrating a media-handling device, comprising the steps of:
a means for placing an actual mark upon a media by a media-handling device;
a means for manually comparing, by a user, said actual mark with a desired mark; and
a means for manually calibrating, if necessary, said media-handling device.

25. The method, as in claim 24, wherein said actual mark is further comprised of:
patches.

26. The method, as in claim 24, wherein said actual mark is further comprised of:
scatter targets.

27. The method, as in claim 24, wherein said actual mark is further comprised of:
gray and color step wedges.

28. The method, as in claim 24, wherein said actual mark is further comprised of:
resolution targets.

29. The method, as in claim 24, wherein said actual mark is further comprised of:
fixing targets.

30. The method, as in claim 24, wherein said media is further comprised of:
paper.

31. The method, as in claim 24, wherein said media-handling device is further comprised of:
a printer.

32. The method, as in claim 24, wherein said placing means is further comprised of the step of:
a means for printing said mark on said media.

33. The method, as in claim 31, wherein said placing means is further comprised of the step of:
a means for printing said mark on said media with said printer.

34. The method, as in claim 24, wherein said calibrating means is further comprised of the step of:
a means for adjusting various process parameters of said media-handling device.

35. The method, as in claim 24, wherein said means for manually calibrating is further comprised of the steps of:
a means for placing a second actual mark upon said media by said media-handling device;
a means for manually comparing, by said user, said second actual mark with said desired mark; and
a means for manually calibrating, if necessary, said media-handling device.
